(19) United States
(12) Patent Application Publication
(10) Pub. No.: US 2008/0310659 A1
(43) Pub. Date: Dec. 18, 2008

(54) Hearing Aid Having Feedback Signal Reduction Function

(75) Inventors: Sun-ill Kim, Seoul (KR); In-young Kim, Seoul (KR); Sang-min Lee, Seoul (KR); Yoon-sang Ji, Seoul (KR); Se-young Jung, Seoul (KR)

Correspondence Address: HUSCH BLACKWELL SANDERS LLP, 720 OLIVE STREET, SUITE 2400, ST. LOUIS, MO, 63101, US

(73) Assignee: Industry-University Cooperation Foundation Hanyang University, Seoul (KR)

(21) Appl. No.: 12/064,473

(22) PCT Filed: Dec. 22, 2005
(86) PCT No.: PCT/KR05/04443

§ 371 Date: Aug. 18, 2008

(30) Foreign Application Priority Data
Aug. 24, 2005 (KR) 10-2005-0078031

(51) Int. Cl. H04R 25/00

(52) U.S. Cl. 381/316

(57) ABSTRACT

The present invention relates to a hearing aid having feedback signal reduction function. A preferred embodiment of the hearing aid of the present invention having feedback signal reduction function comprises: a microphone; an A/D transformer transforming an external sound that is input through the microphone to a digital sound signal; a feedback signal detector detecting the feedback signal by testing a specific range of frequency from the digital sound signal; a feedback signal reducer, operated by the control of the feedback signal detector, renewing the coefficient of correlation of an adaptive filter, to which independent component analysis (ICA) is applied, and reducing the feedback signal; a frequency amplifier amplifying the digital sound signal by use of the compensation gain information per frequency to fit the pre-determined characteristics of hearing loss; a D/A transformer transforming the digital sound signal to an analog sound signal; and a receiver Accordingly, the present invention can reduce the feedback signal to deliver high-quality voice signals only.

### TECHNICAL FIELD

This document relates to a hearing aid.

### BACKGROUND ART

The human hearing organ consists of the external ear, middle ear, and internal ear. The mechanism for hearing the sound by a human ear is as follows: The sound energy delivered through a chain delivery process of air particles is primarily collected by the external ear in the skull, and vibrates the ear drum with the resonant frequency of between 2,000 Hz and 5,000 Hz due to the structural characteristics of the external auditory canal. This delivers the sound energy to the internal ear through the middle ear, the sound energy shaking the lymph inside the cochlear duct. The thousands of fine fibroblasts in the middle layer of the cochlear duct sense the movement of the lymph to transform to electrical energy. As this electrical energy is delivered to the brain through the auditory nerve, a human hears the sound.

For patients with impaired hearing, however, whose hearing is either weaker or lost due to flawed delivery of such sound or electrical energy, a hearing aid that can compensate for the sound or electrical energy is imperative. A hearing aid is a device that allows the hearing impaired to perceive the sound in the level of a normal person by amplifying or transforming the sound in the bandwidth in which normal persons can hear the sound. Such hearing aid should be able to deliver clear speech to the wearer of the hearing aid so as that the wearer can discriminate the speech regardless of the level of noise in the surrounding environment. Conventional hearing aids, however, generate the feedback signal much too easily and frequently due to their structural characteristics.

FIG. 1 is an illustration of the path of a typical feedback signal generated in a hearing aid. As shown in FIG. 1, the hearing aid 100 is designed, due to the structural characteristics, for a direct insertion into the human external auditory canal. This causes an occlusion effect, resulting in discomfort while wearing the hearing aid. This was resolved by creating a vent 130 in the hearing aid 100.

### DISCLOSURE OF INVENTION

### Technical Problem

However, as the external signal that is input through the microphone 110 of the hearing aid 100 is output through the receiver 120, and the signal output through the receiver 120 is re-input through the vent 130, a feedback signal is generated. Such feedback signal in turn generates a howling due to the signal loop, and the pitch (squeaking high pitch or explosive low pitch) of the howling gives discomfort to the wearer of the hearing aid, making the use of the hearing aid increasingly difficult.

Moreover, the feedback signal in the hearing aid can occur quite frequently by a variety of causes, such as inserting the hearing aid, leaking of the output signal when moving the mouth, approaching a hand to the microphone, and the signal re-input to the microphone due to the reflection by an object such as a telephone handset.

### Technical Solution

In order to solve the above problems, the present invention aims to provide a hearing aid that can deliver the high-quality voice signals only (voice signals in which the speech can be discriminated) by reducing the feedback signal generated due to the structural characteristics of the hearing aid.

Another objective of this invention is to provide a hearing aid that can eliminate the inconvenience and/or discomfort, caused by the generation of the feedback signal, by reducing the feedback signal generated while wearing or removing the hearing aid and reducing the howling generated by the feedback signal.

Another objective of this invention is to provide a hearing aid that allows the wearer of the hearing aid not to carry a remote control that is needed to control the hearing aid to reduce the feedback signal generated in the hearing aid.

### Advantageous Effects

As described earlier, with a hearing aid having feedback signal reduction function based on the present invention, delivery of high-quality voice signals only (voice signals that can deliver discriminable speech only) can be achieved by reducing the feedback signal that is generated due to the structural characteristics of a hearing aid.

This invention also provides a hearing aid that can eliminate the inconvenience and/or discomfort, caused by the generation of the feedback signal, by reducing the feedback signal generated while wearing or removing the hearing aid and reducing the howling generated by the feedback signal.

Moreover, this invention provides a hearing aid that allows the wearer of the hearing aid not to carry a remote control that is needed to control the hearing aid to reduce the feedback signal generated in the hearing aid.

Although the present invention was described above by referring to a preferred embodiment of the present invention, any person of ordinary skill in the art should be able to understand that this invention may be variably modified or altered within the scope of not departing from the idea and domain of this invention stated in the claims below.

### BRIEF DESCRIPTION OF THE DRAWINGS

FIG. 1 is an illustration of the path of a typical feedback signal generated in a hearing aid.

FIG. 2 is a block diagram of the structure of a hearing aid based on a preferred embodiment of the invention.

FIG. 3 is a block diagram of the signal processor of a hearing aid based on a preferred embodiment of the invention.

FIG. 4 is an illustration of the digital sound signal, transformed to the frequency range, in a graph before the feedback signal is generated in a hearing aid.

FIG. 5 is an illustration of the digital sound signal, transformed to the frequency range, in a graph after the feedback signal is generated in a hearing aid.

FIG. 6 is the flowchart of the signal processor for detecting and reducing the feedback signal, based on a preferred embodiment of the invention.

FIG. 7 is the block diagram for reducing the feedback signal by use of an adaptive filter, to which independent component analysis is applied, based on a preferred embodiment of the invention.

FIG. 8 is an illustration of the frequency signal after reducing the feedback signal by use of an adaptive filter, to which independent component analysis is applied, based on a preferred embodiment of the invention.

FIG. 9 is an illustration of the frequency signal after reducing the feedback signal by use of an adaptive filter using the conventional normalized least mean square.

FIG. 10 is the flowchart for reducing the feedback signal, based on a preferred embodiment of the invention.

### A LIST OF THE NUMBERS IDENTIFYING MAJOR PARTS SHOWN IN THE DRAWINGS

210: microphone

215: pre-amplifier

220: A/D transformer

225: signal processor

230: storage

235: D/A transformer

240: post-amplifier

245: receiver

310: frequency range transformer

320: feedback signal detector

330: feedback signal reducer

340: frequency amplifier

350: time range transformer

### Mode for the Invention

The following paragraphs describe a preferred embodiment in detail by making reference to the attached drawings:

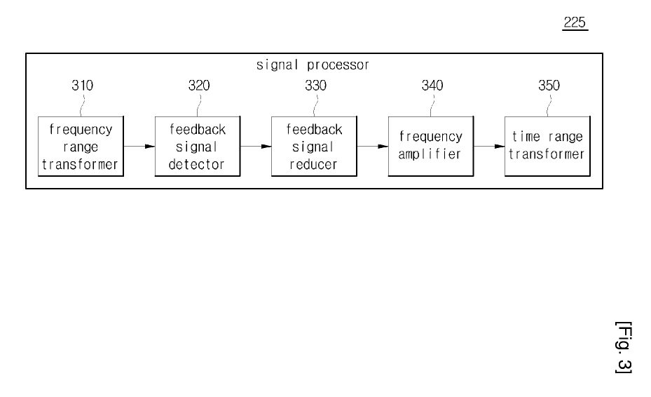

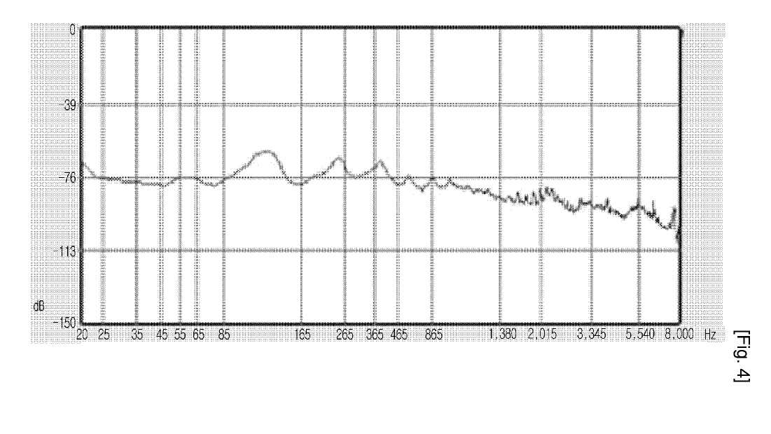

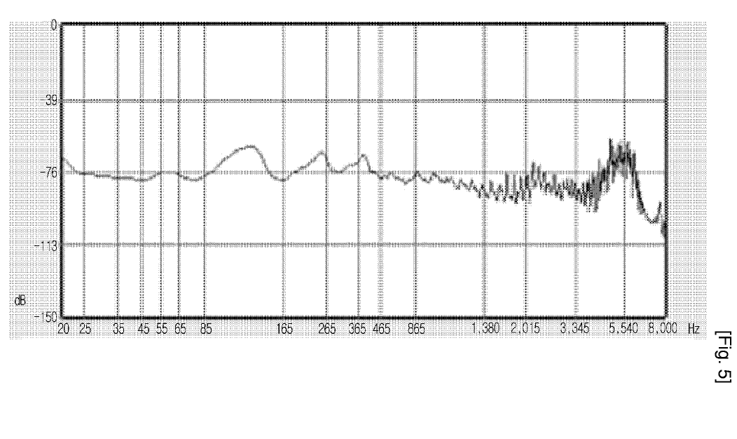

FIG. 2 is a block diagram of the structure of a hearing aid based on a preferred embodiment of the present invention; FIG. 3 a block diagram of the signal processor of a hearing aid based on a preferred embodiment of the invention; FIG. 4 an illustration of the digital sound signal, transformed to the frequency range, in a graph before the feedback signal is generated in a hearing aid; and FIG. 5 an illustration of the digital sound signal, transformed to the frequency range, in a graph after the feedback signal is generated in a hearing aid.

As shown in FIG. 2, the hearing aid 200 comprises a microphone 210, a pre-amplifier 215, an A/D transformer 220, a signal processor 225, a storage 230, a D/A transformer 235, a post-amplifier 240, and a receiver 245.

The microphone 210 receives an external sound signal, transforms to an analog electrical signal, and sends the analog electrical signal to the pre-amplifier 215.

The pre-amplifier 215 amplifies the analog electrical signal, input from the microphone 210, to a predetermined level and sends the amplified analog electrical signal to the A/D transformer 220.

The A/D transformer 220 transforms the analog electric signal, input from the pre-amplifier 215, to a digital sound signal and sends the digital sound signal to the signal processor 225.

The signal processor 225 processes the digital sound signal, sent from the AID transformer 220, using the algorithm (e.g., compensation algorithm per frequency, feedback signal reduction algorithm, sound quality improvement algorithm) pre-stored in the storage 230 and sends the processed digital sound signal to the D/A transformer. As an example, the signal processor 225 checks the digital sound signal sent from the A/D transformer 220 for a feedback signal, and if a feedback signal is included, the signal processor reduces the feedback signal and sends the digital sound signal to the D/A transformer 235.

As shown in FIG. 3, the signal processor 225 based on this invention comprises a frequency range transformer 310, a feedback signal detector 320, a feedback signal reducer 330, a frequency amplifier 340, and a time range transformer 350.

The components of the signal processor 225 based on the present invention are described in detail in FIG. 3. The frequency range transformer 310 transforms the digital sound signal transformed through the A/D transformer 220 to a frequency range and sends to the feedback signal detector 320. The frequency range transformer 310 may utilize the Discrete Fourier Transform (DFT), Fast Fourier Transform (FFT), Discrete Cosine Transform (DCT), Polyphase Filter Bank, or Quadrature Mirror Filter (QMF), which will not be described here since they are familiar to those of ordinary skill in the art to which the invention pertains.

The feedback signal detector 320 searches for a specific frequency range, in which a feedback signal is generated, in the frequency range transformed through the frequency range transformer 310 in order to determine whether the digital sound signal sent from the A/D transformer 220 contains a feedback signal. Moreover, the feedback signal detector 320 can control the feedback signal reducer 330 to operate if it is determined that the digital sound signal contains a feedback signal.

For example, the feedback signal detector 320 can search for a specific (major) frequency range only, in which a feedback signal is generated, using the BANF. FIG. 4 illustrates the digital sound signal, transformed to the frequency range, in a graph before the feedback signal is generated, and FIG. 5 illustrates the digital sound signal, transformed to the frequency range, in a graph after the feedback signal is generated. As described earlier, most of the feedback signals are generated because the signal that is output through the receiver 245 is leaked through the vent, which is designed to prevent the occlusion effect from wearing the hearing aid, and re-input through the microphone 210. Among these feedback signals, the feedback signal in the same position with, but in the same level of or a level of higher than, the input signal is weakened by 40˜50 dB as it passes through the path of feedback, but the feedback signal in some of the narrower frequency band of the feedback path is weakened by only about 20 dB. Meanwhile, since the amplification gain of the hearing aid is typically 15˜50 dB, the feedback signal can easily reach a volume near the input signal. This becomes a limiting factor to the maximum usable gain for the hearing impaired who need greater amplification. It can be seen in FIGS. 4 and 5 that a certain frequency range is excessively amplified when the feedback signal is included in the digital sound signal. Therefore, the feedback signal detector 320 can detect the feedback signal contained in the digital sound signal using the BANF, which can search for a specific frequency range in the digital sound signal that is transformed in and input from the frequency range transformer 310.

For instance, the feedback signal detector 320 renews the coefficient of correlation of the BANF in order to search for a specific frequency range using the BANF, determines that a feedback signal is contained in the digital sound signal when a frequency exceeding the predetermined threshold is detected in the searched frequency of the specific frequency range, and can control the feedback signal reducer 330 to operate.

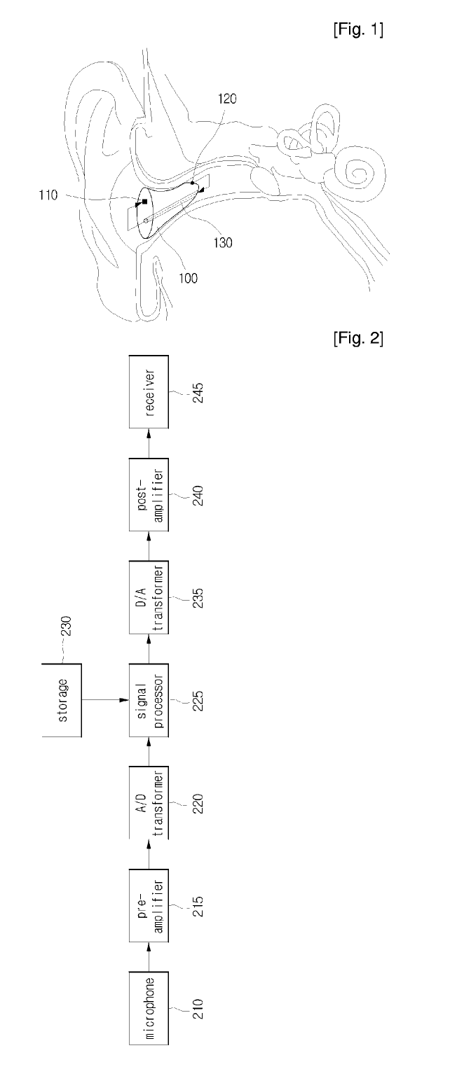

The feedback signal reducer 330, operated by the control of the feedback signal detector 320, reduces the feedback signal contained in the digital sound signal, input from the feedback signal detector 320, and sends the digital sound signal to the frequency amplifier 340. For example, the feedback signal reducer 330 may have an adaptive filter, to which the ICA algorithm is applied, in order to reduce the feedback signal. The feedback signal reducer 330 can renew the coefficient of the adaptive filter to reduce the feedback signal by calculating the renew value of the coefficient of the adaptive filter using the ICA algorithm. Provided below is a brief description of the ICA algorithm: The ICA is a method for separating statistically independent original signals from linearly mixed signals. The signal sources, input through the microphone 210, may be expressed as Math FIGURE 1.

$${x}_{i} = {\sum }_{j = 1}^{N} {a}_{ij} {s}_{j} \qquad MathFigure 1$$

where N is an arbitrary integer indicating the number of independent sound signals, and s1, s2, . . . , sⱼ are independent signal sources of j sounds, and xᵢ is a signal linearly combined by aᵢⱼ.

Take a conference room, where a number of people are talking at the same time, as an example. The sounds generated in the conference room, such as voices of people and sounds made by objects (e.g., flipping the paper, computer noises, etc.), are mixed and input to the microphone 210 of the hearing aid 200 simultaneously. The ICA algorithm is a concept, using the signal detected in the sensor only, for separating individual sounds. The process of individual sounds getting mixed is defined as the mixing matrix. Therefore, the numerical formula defined in Math FIGURE 1 can be expressed as a multiplication of the mixing matrix and the original signal, as in Math FIGURE 2.

x=As MathFigure 2

where A is a mixing matrix, and s is an original sound. The ICA can restore the original signal by finding the reverse matrix of the mixing matrix A using the signal x only, which is measured through an input device such as a microphone. Therefore, the unmixing matrix W, which is the reverse matrix of the mixing matrix A, must be deduced. The original signal s can be calculated using Math FIGURE 3 below:

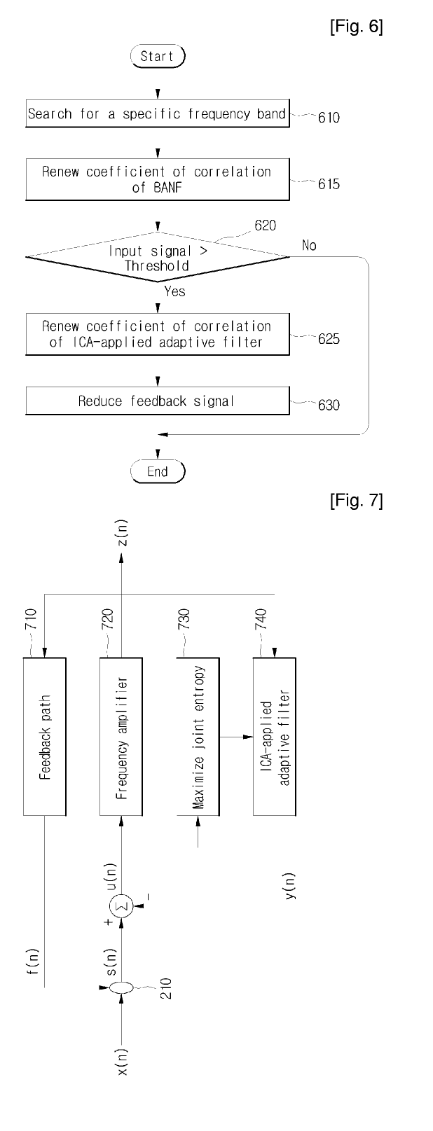

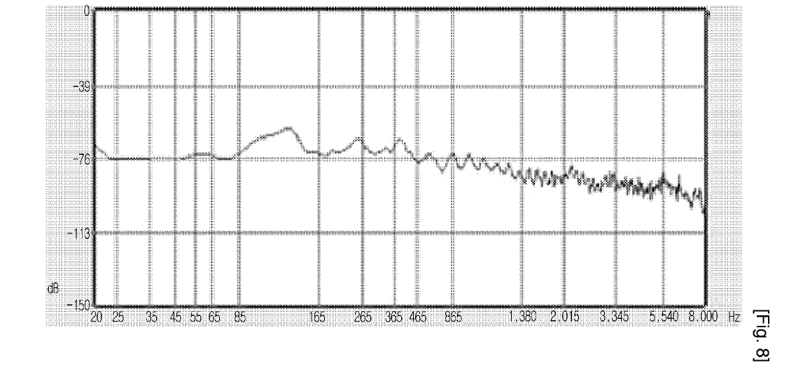

s=A⁻¹x=Wx MathFigure 2

where, for the purpose of deducing the unmixing matrix W, the signal sources are assumed to be independent from one another. That the signal sources for deducing the unmixing matrix W of the ICA algorithm are independent from one another is a basic premise of the ICA algorithm, with which those of ordinary skill in the art are familiar, and hence will not be explained in detail here. The method of reducing the feedback signal using the ICA based on the present invention will be explained later in detail by making reference to FIGS. 6 and 7.

The frequency amplifier 340 amplifies the digital sound signal, input through the feedback signal reducer 330, according to the hearing loss characteristics of the hearing aid wearer. The information for each frequency according to the hearing loss characteristics of the hearing aid wearer may be pre-stored in the storage 230.

The time range transformer 350 transforms the digital sound signal, input from the frequency amplifier 340, and outputs to the D/A transformer 235.

Referring to FIG. 2 again, the storage 230 stores the information for each frequency according to the hearing loss characteristics of the hearing aid 200 wearer, the renew value of the coefficient of the adaptive filter in the feedback signal reducer 330, and the algorithm (e.g., BANF algorithm, ICA-applied adaptive filter algorithm, etc.) that is applied to the hearing aid 200 according to the present invention.

The D/A transformer 235 transforms the digital sound signal, input through the signal processor 225, to an analog sound signal and sends to the post-amplifier 240.

The post-amplifier 240 amplifies the analog sound signal, input from the D/A transformer 235, to a predetermined level and sends to the receiver 245.

The receiver 245 outputs the analog sound signal, amplified in and input from the post-amplifier 240. Through this receiver can the hearing impaired (the hearing aid wearer) recognize the sound provided by the hearing aid 220.

Although not illustrated in FIG. 2, the embodiment of this invention may additionally comprise a power supply, for the purpose of supplying electric power to each device in the hearing aid 200, and a battery socket.

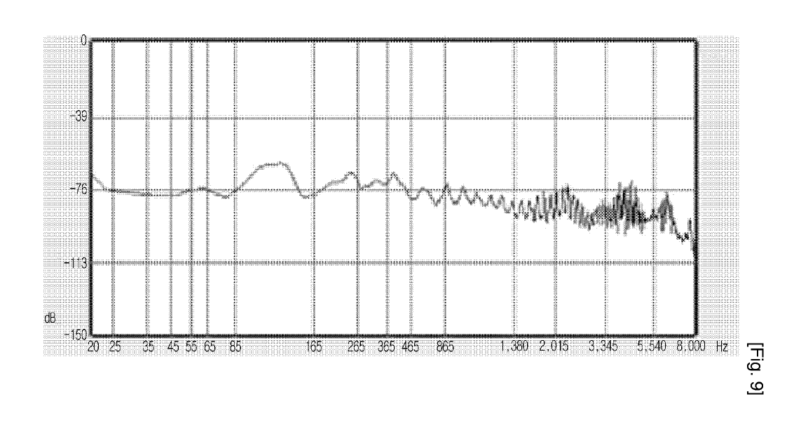

FIG. 6 is the flowchart of the signal processor for detecting and reducing the feedback signal, based on a preferred embodiment of the invention. FIG. 7 is the block diagram for reducing the feedback signal by use of an adaptive filter, to which ICA is applied, based on a preferred embodiment of the invention. FIG. 8 is an illustration of the frequency signal after reducing the feedback signal by use of an adaptive filter, to which ICA is applied, based on a preferred embodiment of the invention. FIG. 9 is an illustration of the frequency signal after reducing the feedback signal by use of an adaptive filter using the conventional normalized least mean square.

Referring to FIG. 6, the feedback signal detector 320 searches for a specific frequency band during steps 610 and 615 once a digital sound signal is input. As described earlier, the feedback signal detector 320 may comprise a BANF. Since there are a limited number of paths in which a feedback signal can be generated, the feedback signal contained in a digital sound signal can be detected by searching for a specific frequency range only in the input digital sound signal using the BANF, which searches for a specific frequency range only. As shown in FIG. 4, for example, since the feedback signal is over-amplified between 1,000 Hz and 8,000 Hz, the feedback signal can be detected by testing the band between 1,000 Hz and 8,000 Hz using the BANF.

As described earlier, most of the feedback signals are generated because the signal output through the receiver 245 is leaked through the vent, which is designed to prevent the occlusion effect from wearing the hearing aid, re-input through the microphone 210, and repeatedly amplified. This kind of feedback signal results in an abnormal sound pitch (i.e., squeaking high pitch or explosive low pitch), giving discomfort to the hearing aid wearer.

The BANF renews the coefficient of correlation of the BANF in order to search by frequency, and searches for a frequency in a specific frequency range. The coefficient of correlation of the BANF is renewed because the BANF requires the coefficient of the filter, corresponding to the pertinent frequency, in order to search for an arbitrary frequency.

In step 620, the feedback frequency detector 320 determines whether a feedback signal is included in the digital sound signal by determining whether the input digital sound signal exceeds the predetermined threshold. For example, the feedback signal detector 320 determines that the digital sound signal contains a feedback signal if the input signal level of the digital sound signal exceeds the predetermined threshold. A feedback signal tends to have a high dB level because it is repeatedly amplified. Therefore, the minimum intensity of the feedback signal that can be considered as a feedback signal in an experiment can be set as the threshold, and the feedback signal can be detected by comparing the power level of the largest signal among the components of the signal input from the microphone 210, for example, with the threshold set through the experiment.

Once it is determined that the digital sound signal contains a feedback signal, the feedback signal detector 320 controls the feedback signal reducer 330 to operate in step 625. Then, the feedback signal reducer 330 renews the coefficient of correlation of the ICA-applied adaptive filter. To help understand, the method of calculating the filter coefficient of the ICA-applied adaptive filter for a hearing aid based on the present invention is described as follows: Referring to FIG. 7, x(n) and z(n) are independent from each other and are assumed to have a non-gaussian distribution. Each of

e₁(n)

and

e₂(n)

is a value that passed a non-linear function that approximates the cumulative distribution function (CDF) of x(n) and z(n), respectively, and can be calculated with Eqs. 4 and 5 below:

e₁(n)=g(x(n)) MathFigure 4

e₂=g(z(n)) MathFigure 5

in which g( ) is a non-linear function that approximates the CDF.

The joint entropy between the input signal x(n) and output signal z(n) is identical to the difference between the entropy of each signal and the mutual information of the two signals, and can be calculated with Math FIGURE 6 below:

$$\begin{matrix}H ( e ) = - \sum {f}_{e} ( e ) log {f}_{e} ( e ) \\ = - E [ log {f}_{e} ( e ) ] \\ = - E [ log ( \frac{{f}_{I} ( I )}{\vert J \vert} ) ] \\ = E ⌈ log \vert J \vert ⌉ + H ( I )\end{matrix} \qquad MathFigure 6$$

where E is an expectation value, and

fₑ(e)

is the probability mass function (PMF) of e. And since the probability density function (PDF) of the output signal does not change although the PDF of the input signal is divided by a jacobian determinant in order to fmd the marginal entropy, Math FIGURE 6 can be obtained. In other words,

$${f}_{e} ( e ) and \frac{{f}_{I} ( I )}{\vert J \vert}$$

are the same. Moreover, |J| is an jacobian determinant, expressed as Math FIGURE 7.

$$\vert J \vert = \frac{\partial {e}_{1}}{\partial z} \frac{\partial {e}_{2}}{\partial x} - \frac{\partial {e}_{1}}{\partial x} \frac{\partial {e}_{2}}{\partial z} \qquad MathFigure 7$$

Partial differentiating Math FIGURE 6 with w by applying the statistical gradient increase method to maximize the entropy for the output of the non-linear function results in

$$\frac{\partial }{\partial w} H ( I ) = 0 ,$$

and Math FIGURE 6 can be expressed as Math FIGURE 8 below:

$$Δ ω = \frac{\partial }{\partial ω} E ⌈ log \vert J \vert ⌉ \qquad MathFigure 8$$

Here, when the coefficient w of the adaptive filter is renewed so as that the information between the system outputs expressed in a jacobian form, and the sigmoid function e is a CDF of the super-gaussian PDF, the learning algorithm of w can be expressed as Math FIGURE 9.

$$\begin{matrix}Δ ω ∝ \frac{\partial }{\partial ω} log f ( μ ⌈ n ⌉ ) = {( \frac{\partial {e}_{1} ⌈ n ⌉}{\partial μ ⌈ n ⌉} )}^{- 1} \frac{\partial }{\partial ω} ( \frac{\partial {e}_{1} ⌈ n ⌉}{\partial μ ⌈ n ⌉} ) \\ = ϕ ( μ ⌈ n ⌉ ) x ⌈ t - n ⌉\end{matrix} \qquad MathFigure 9$$

where

(φ(μ┌n┐)

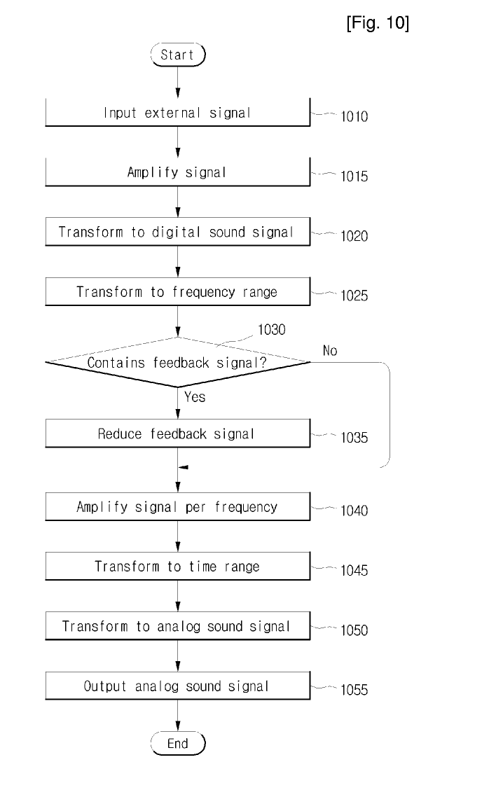

is a score function, which is the PDF of u(n) showing the difference between the input signal x(n) and output signal z(n), which is renewed and output by the adaptive filter.
For a score function, this specification uses a sign function, which approximates the CDF of super-gaussian distribution. This allows the use of Math FIGURE 10 below for the calculation of the renew value of the adaptive filter coefficient using the ICA algorithm.

$$ω ( n + 1 ) = ω ( n ) + \frac{μ}{‖ y ( n ) ‖ + δ} ϕ ( μ ( n ) ) y ( n ) \qquad MathFigure 10$$

For example, f(n) refers to the signal that comes in through the feedback path 410. The input signal x(n) is mixed with the feedback signal (f(n)) in the microphone 210, that is the mixed signal s(n) is the sum of the input signal and the feedback signal f(n). Here, continually testing a specific frequency range of the mixed signal s(n) using the BANF verifies the generation of the feedback signal f(n). Moreover, u(n) can be obtained by subtracting y(n), the signal resulted from the output signal z(n) passing through the ICA-applied adaptive filter 440, from the mixed signal s(n). In other words, u(n) can be obtained by the difference between the outputs of the feedback path and of the adaptive filter. u(n) is amplified per frequency to fit the hearing loss characteristics of the hearing aid wearer, and the output signal z(n) is output. Here, if the feedback signal detector 320 determines that a feedback signal is included in the digital sound signal, the feedback signal detector 320 can control the feedback signal reducer 330 to operate. The feedback signal reducer 330, operated by the control of the feedback signal detector 320, can renew the coefficient of correlation of the filter to write the calculated (e.g., Math FIGURE 10) renew value of the coefficient of correlation of the ICA-applied adaptive filter by calculating (e.g., Math FIGURE 6) H(e) that maximizes the joint entropy of u(n). And the feedback signal reducer 330 can output y(n) by passing the output signal z(n) through the ICA-applied adaptive filter and the feedback-signal-reduced u(n) by subtracting y(n) from the mixed signal s(n). In the block diagram shown in FIG. 7, between the signal y(n), which passed through the ICA-applied adaptive filter 440, the feedback signal f(n), which is received through the feedback path, and the input signals x(n) and u(n) exist some time differences, which are insignificant and hence will be ignored.

In step 630, the feedback signal reducer 330 reduces the feedback signal from the digital sound signal, input from the feedback signal detector 320, using the renewed ICA-applied adaptive filter and sends the digital sound signal to the frequency amplifier 340.

However, if the feedback signal detector 320 determines in step 620 that the feedback signal is not contained in the digital sound signal, the feedback signal detector 320 sends the digital sound signal to the frequency amplifier 340.

FIG. 8 is an illustration of the signal expressed in the frequency range after reducing the feedback signal using the ICA-applied adaptive filter according to this invention, and FIG. 9 is an illustration of the signal expressed in the frequency range after reducing the feedback signal using the conventional normalized least mean square (NLMS). By comparing FIGS. 8 and 9, it can be verified that the adaptive filter with the ICA application reduces the feedback signal more effectively than that with the NLMS does, particularly in the frequency range between 3,300 Hz and 5,500 Hz. As shown in FIGS. 8 and 9, the ICA algorithm is more effective in expressing the signals of non-gaussian characteristics, which are identical to the real sound distribution, than the NLMS algorithm, which uses the secondary statistical method for the difference between the input signal and feedback signal, is.

FIG. 10 is the flowchart for reducing the feedback signal based on a preferred embodiment of the present invention.

Referring to FIG. 10, the hearing aid 200 according to this invention receives an external signal through the microphone 210 in step 1010, transforms to an electrical signal, and sends to the pre-amplifier 215. As described earlier, the external signal that is input through the microphone 210 can be a mixed signal, for example, of the feedback signal, which is input after the signal that has been input through the microphone 210 of the hearing aid 200 and output through the receiver 245 is fed back through the vent, human voices, and sound signals of objects.

In step 1015, the pre-amplifier 215 amplifies the electrical signal, input from the microphone 210, to a predetermined level and sends to the A/D transformer 220.

In step 1020, the A/D transformer 220 transforms the electrical signal, amplified in and input from the pre-amplifier 215, to a digital sound signal and sends to the frequency range transformer 310.

In step 1025, the frequency range transformer 310 transforms the digital sound signal, input from the A/D transformer 220, to a frequency range and sends to the feedback signal detector 320.

In step 1030, the feedback signal detector 320 tests the frequency band of the digital sound signal, transformed in the frequency range transformer 310, and detects a feedback signal contained in the digital sound signal. For instance, the feedback signal detector 320 tests a specific frequency band using the BANF to determine the inclusion of a feedback signal.

If no feedback signal is detected, the process goes to step 1040.

If a feedback signal is detected, however, the feedback signal detector 320 sends the digital sound signal to the feedback signal reducer 330 and controls the feedback signal reducer 330 to operate, and, in step 1035, the feedback signal reducer 330 reduces the feedback signal in the digital sound signal using the ICA-applied adaptive filter and sends the digital sound signal to the frequency amplifier 340.

The digital sound signal is amplified through the frequency amplifier 340 to fit the hearing loss characteristics of the hearing aid 200 wearer (step 1040), and is transformed from the frequency range to a time range through the time range transformer 350 (step 1045).

In step 1050, the D/A transformer 235 transforms the digital sound signal to an analog sound signal and sends the analog sound signal to the post-amplifier 240. The analog sound signal, input to the post-amplifier 240, is amplified according to the pre-determined level and output through the receiver 245 (step 1055).

As described earlier, a hearing aid embodying the present invention can deliver high-quality signals only to the hearing aid wearer by effectively reducing the feedback signal using the ICA-applied adaptive filter when the feedback signal is generated in the hearing aid embodying the present invention. Therefore, the hearing aid wearer can recognize the speech more accurately.

### INDUSTRIAL APPLICABILITY

As described earlier, with a hearing aid having feedback signal reduction function based on the present invention, delivery of high-quality voice signals only (voice signals that can deliver discriminable speech only) can be achieved by reducing the feedback signal that is generated due to the structural characteristics of a hearing aid.

This invention also provides a hearing aid that can eliminate the inconvenience and/or discomfort, caused by the generation of the feedback signal, by reducing the feedback signal generated while wearing or removing the hearing aid and reducing the howling generated by the feedback signal.

Moreover, this invention provides a hearing aid that allows the wearer of the hearing aid not to carry a remote control that is needed to control the hearing aid to reduce the feedback signal generated in the hearing aid.

1-10. (canceled)

11. A hearing aid having feedback signal reduction function comprising:
a microphone adapted to receive an external sound signal and to transform the received external sound signal to an electrical sound signal;
an A/D transformer for transforming said electrical sound signal to a digital sound signal;
a feedback signal detector configured for detecting a feedback signal included in the digital sound signal by testing a specific range of frequency wherein the feedback signal is generated frequently;
a feedback signal reducer for reducing the feedback signal from the digital sound signal by using independent component analysis (ICA), the feedback signal reducer being operated by control of the feedback signal detector;
a frequency amplifier for amplifying the digital sound signal by using compensation gain information per frequency to fit the pre-determined characteristics of hearing loss;
a D/A transformer for transforming the amplified digital sound signal to an analog sound signal; and
a receiver adapted to output the transformed analog sound signal.

12. The hearing aid of claim 11, wherein:
said feedback signal detector instructing said feedback signal reducer to operate if said feedback signal detector detects a feedback signal included in the digital sound signal, and to bypass the digital sound signal if said feedback signal detector does not detect a feedback signal in the digital sound signal;
the feedback signal reducer renewing coefficient of correlation of an adaptive filter only if the feedback signal detector detects the feedback signal; and
said ICA being applied to said adaptive filter.

13. The hearing aid of claim 11, further comprising:
a frequency range transformer for transforming the digital sound signal transformed in the A/D transformer to a frequency range and for outputting the digital sound signal transformed to the frequency range to the feedback signal detector; and
a time range transformer for transforming the digital sound signal in the frequency range to a time range and for outputting the digital sound signal transformed to the time range to the D/A transformer.

14. The hearing aid of claim 11, further comprising a storage adapted to store the information on compensation gain per frequency or the signal process algorithm that fits characteristics of hearing loss of a hearing aid wearer.

15. The hearing aid of claim 11, wherein said external sound signal and said analog sound signal have non-Gaussian characteristics.

16. The hearing aid of claim 11, further comprising:
a pre-amplifier connected to said microphone, said pre-amplifier amplifying said external sound signal received by said microphone to a predetermined size; and
a post-amplifier connected to said D/A transformer, said post-amplifier amplifying said transformed analog sound signal to a predetermined size and outputting said amplified analog sound signal through said receiver.

17. The hearing aid of claim 11, wherein said feedback signal detector testing a specific frequency of the digital sound signal by using a band adaptive notch filter (BANF) and renewing coefficient of correlation of the BANF corresponding to the frequency in order to test a random frequency.

18. The hearing aid of claim 11, wherein said feedback signal reducer including an adaptive filter, said adaptive filter calculating coefficient of the adaptive filter by using mutual information that minimizes information between said external sound signal and said analog sound signal.

19. The method of reducing the feedback signal by the hearing aid, comprising the steps of:
receiving an external sound signal through a microphone;
transforming said received external sound signal to an electrical signal;
transforming the electrical signal to a digital sound signal;
testing a specific frequency in the digital sound signal and detecting a feedback signal included in the digital sound signal;
reducing the feedback signal from the digital sound signal by using an adaptive filter if a feedback signal is detected, said adapted filter using an ICA algorithm;
amplifying said digital sound signal by using compensation gain information per frequency to fit the predetermined hearing loss characteristics; and
transforming the amplified digital sound signal to an analog sound signal and outputting said analog signal through a receiver.

20. The method of reducing the feedback signal by the hearing aid of claim 19, further comprising the steps of:
continually renewing coefficient of correlation of a band adaptive notch filter; and
renewing the coefficient of correlation of the adaptive filter if a feedback signal is detected.
